(19) United States
(12) Patent Application Publication
(10) Pub. No.: US 2005/0104332 A1
(43) Pub. Date: May 19, 2005

(54) Wheelchair with self-raising seat

(76) Inventor: Chin-Lu Hsu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/714,622

(22) Filed: Nov. 18, 2003

(51) Int. Cl. A61G 5/00

(52) U.S. Cl. 280/650

(57) ABSTRACT

The present invention relates a raising wheelchair comprising two rigid frames, two fixing combinations, two lever combinations and a transformation combination. The rigid frame is connected to a wheel and has a front cross frame coupled between the rigid frames. The fixing combinations further comprise a linking frame and tooth frame, whereby the linking frame enfolds the tooth frame and couples to said rigid frame. The tooth frame comprises a tooth fitting. The lever combination is located at the top of said rigid frame and further comprises a rear cross frame coupled between said lever combination of lever. The raising wheelchair provides assistance to users for stable, convenient, and independent operation in rising from or sitting into the chair.

### BACKGROUND OF THE INVENTION

1. Field of the Invention

The present invention relates to a wheelchair, more specifically, the present invention discloses a wheelchair with raising seat for assisting users in standing and seating which improves a user's independence and safety.

2. Description of the Prior Art

Wheelchairs are a necessary form of transportation for injured patients in daily life. Wheelchairs are particularly useful for seriously injured or disabled persons, who without the wheelchair would be unable to be mobile.

However, a major concern to users is their safety while rising from or sitting into the chair. Typically, another person must assist the chair user while they are rising or sitting. Additionally, the assisting person must lift the body weight of the user while trying to keep the chair stable. Unfortunately, this often can not safely be accomplished, resulting in the chair user slipping or falling or the chair becomes unstable and crashes into nearby objects or bystanders.

As shown above, it is critical to protect users when they are rising or sitting and ensure their safety. Failing or slipping while exiting the chair not only can lead to further injury to the user, but also is embarrassing and lowers the user's confidence. Additionally, if the user is heavy, an assisting person can easily strain muscles or hurt themselves while helping the user rise.

Therefore, there is need for an improved wheelchair that can provide a self-raising support for assisting users and a fixing position for preventing instability.

### SUMMARY OF THE INVENTION

It is an object of the present invention to provide a stable raising wheelchair, which can assist users in independently, conveniently, and stably operating the seat position by themselves.

Another object of the present invention is to provide a safe raising wheelchair, which provides support while users change their position and prevents swinging.

Another object of the present invention is to provide a self operatable wheelchair, which can eliminate the need for assistance and increases a user's confidence.

It is to be understood that both the foregoing general description and the following detailed description are exemplary, and are intended to provide further explanation of the invention as claimed.

### BRIEF DESCRIPTION OF THE DRAWINGS

FIG. 1 is a side view of a wheelchair according to an embodiment of the present invention, when the wheelchair is in a seating position

FIG. 2 is a side view of a fixing section of a wheelchair according to an embodiment of the present invention;

FIG. 3 is a top view showing the frame with gas spring according to an embodiment of the present invention

FIG. 4 is a side view of a wheelchair according to an embodiment of the present invention, when the wheelchair is in a raised position; and

FIG. 5 is a top view illustrating another example of the frame with gas spring according to an embodiment of the present invention.

### DETAILED DESCRIPTION

Reference will now be made in detail to the preferred embodiments of the present invention, examples of which are illustrated in the accompanying drawings. Wherever possible, the same reference numbers are used in the drawings and the description to refer to the same or like parts.

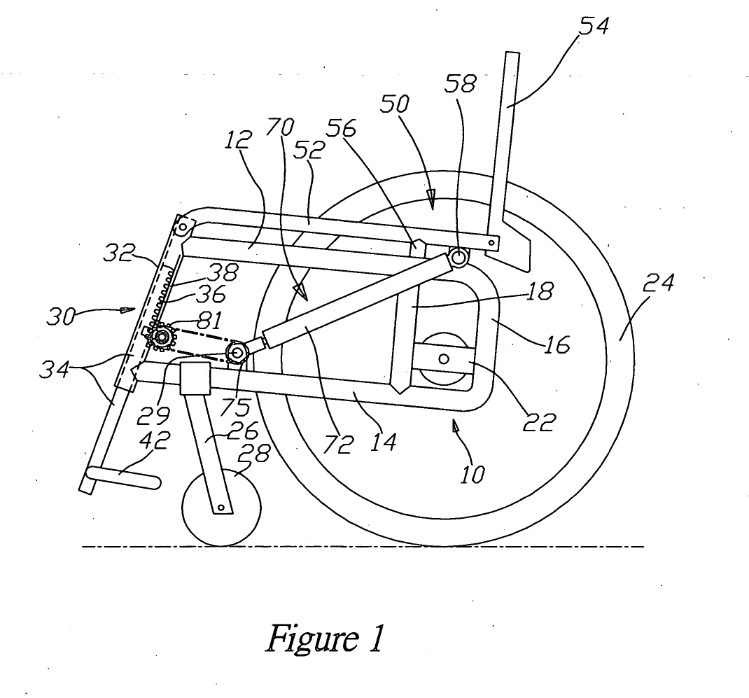

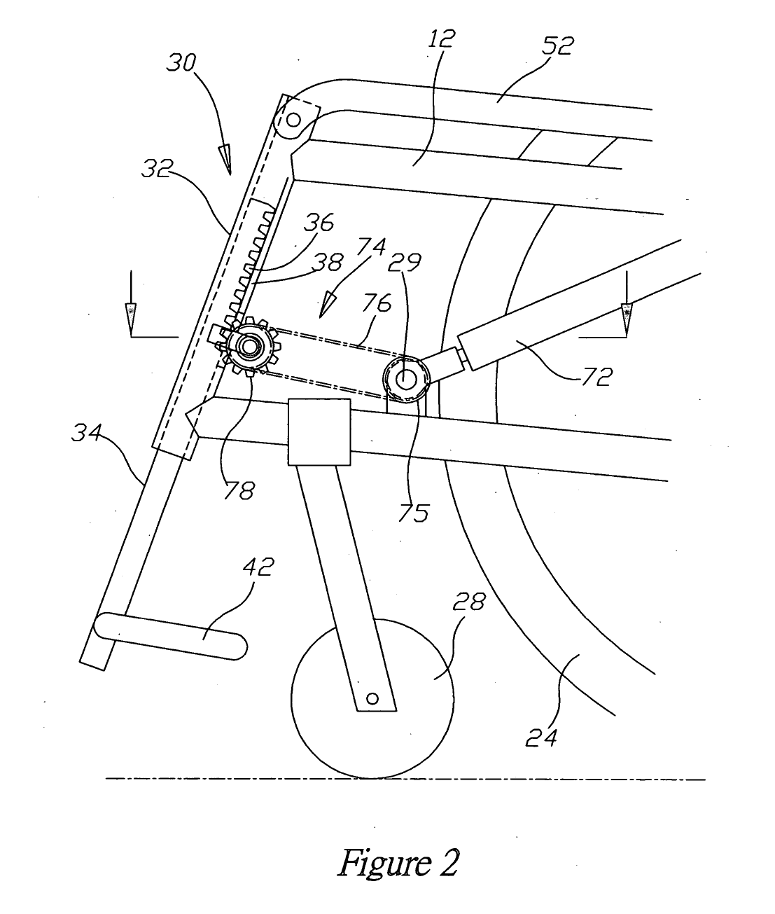

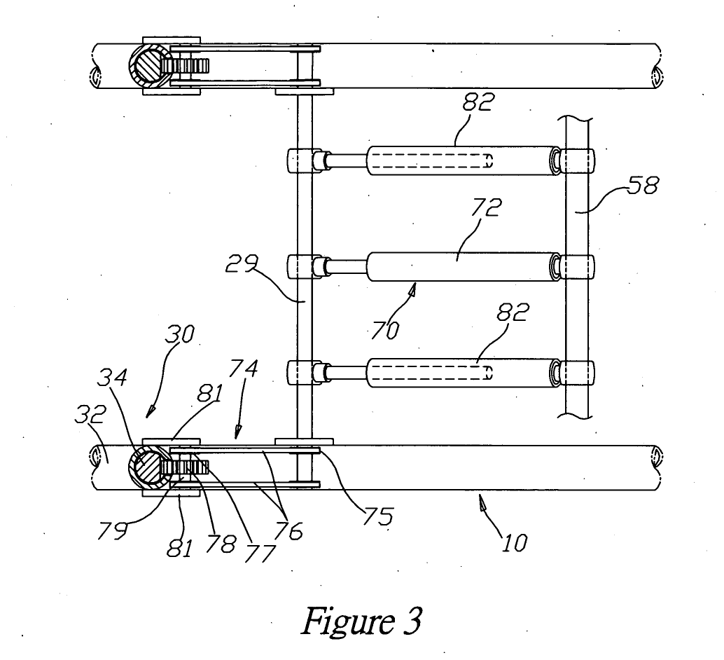

Refer to FIGS. 1, 2 and 3. The raising wheelchair comprises two rigid frames 10, whereby the rigid frame 10 further comprises an upper frame 12, a lower frame 14 and a side vertical frame 16, formed curved and connected to said frame.

A vertical frame 18 is located between upper frame 12 and lower frame 14. A vertical cross major wheel frame 22 couples between the vertical frame 18 and side vertical frame 16, whereby the vertical cross major wheel frame 22 further connects to wheel 24. A front wheel frame 26 couples to the bottom of the lower frame 14 at an appropriate location. A fixing combination 30 is located at the front of the upper frame 12 and the lower frame 14, whereby the fixing combination 30 further has a linking frame 32 and a tooth frame 34.

The fixing combination 30 couples to the upper frame 12 and the lower frame 14 to form a frame body. The linking frame 32 is a hollow tube, which contains a tooth frame 34 with teeth fittings 36 on the rear side of the tooth frame 34.

The tooth frame 34 further comprises a tooth groove 38 arranged in relation to the teeth fittings 36, for linking. At the appropriate location of the tooth frame 34 a frame stop 42 is provided as a stop.

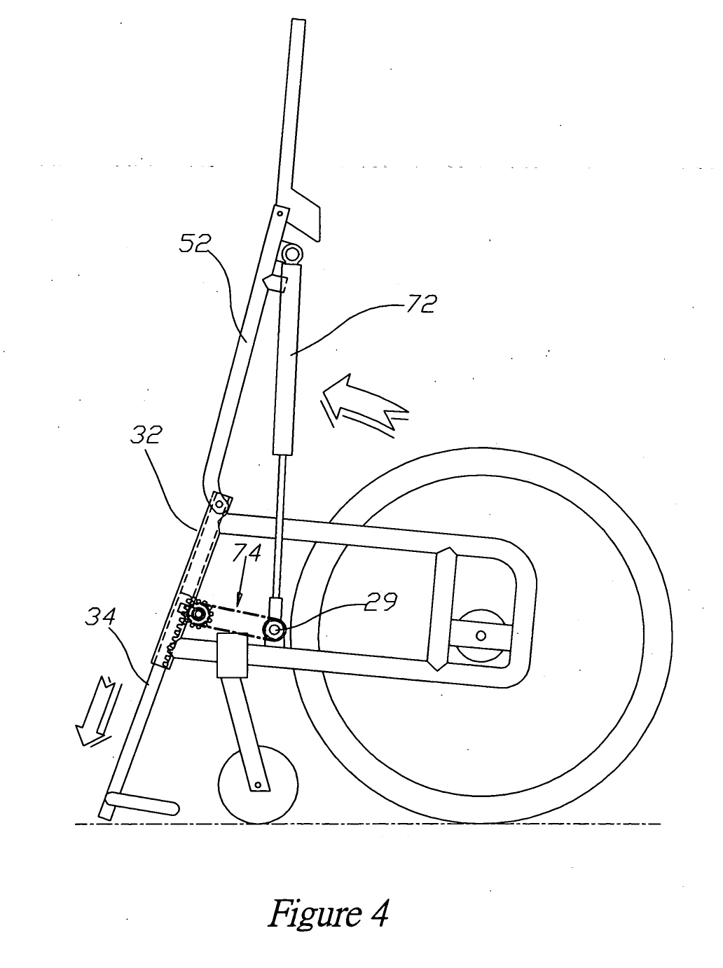

The invention further comprises a lever combination 50 at the top of the rigid frame 0, whereby the, lever combination 50 comprises an arm bar 52 and a lever bar 54. The arm bar 52 can also support or hold a seat cushion. One endpoint of the lever combination 50 couples to the linking frame 32, and another endpoint of the lever combination 50 couples to the lever bar 54. The lever bar 54 and arm bar 52 pivot for holding lever bar 54 at an appropriate angle between a sitting and a raised position of the chair, as shown in FIGS. 1 and 4.

A tab stop 56 is provided at an appropriate location on the arm bar 52 for contacting the rigid frame 10. A rear cross frame 58 is arranged between the two arm bars 52.

An upright combination 70 comprises a gas spring 72 and a transformation combination 74, whereby the gas spring 72 is connected to the front cross frame 29 at one endpoint and connected to the rear cross frame 58 at the other endpoint. The transformation combination 74 comprises a rear gear 75, a chain 76, middle gear 77 and front gear 78. The rear gear 75 couples to the front cross frame 29 at one endpoint, and the middle gear 77 and front gear 78 couple to axial frame 79 which is position in the frame bearing 81 separated from the linking frame 32. The rear gear 75 is connected to the chain 76 and middle gear 77, further linking to the front gear 78 geared to the teeth fittings 36 of the tooth frame 34.

Alternatively, without the chain 76, said rear gear 75 can gear directly to the middle gear 77 thus the rear gear 75 further gears the front gear 78.

Furthermore, between the front cross frame 29 and the rear cross frame 58 a shaft support 82 is provided for increasing the stability when changing positions and responding to control by the transformation combination 74.

Refer to FIG. 4 showing the wheelchair in a raised position. As shown in the drawing, the arm bar 52 is raised by the gas spring 72 which is coupled to the transformation combination or gear set 74. Additionally, since the transformation combination 74 is geared to the teeth 36 of the tooth frame 34, the tooth frame 34 and frame stop 42 move in a downward direction to the ground.

In use, up-right support can be utilized from the arm bar 52 by the user. Such support decreases the bearing weight for assistance and the guide of the tooth frame 34 against the ground prevents instability and changing positions of the chair. Finally, the gearing by combination of the transformation combination 74, the rear gear 75, and the chain 76 can smoothly achieve the above process.

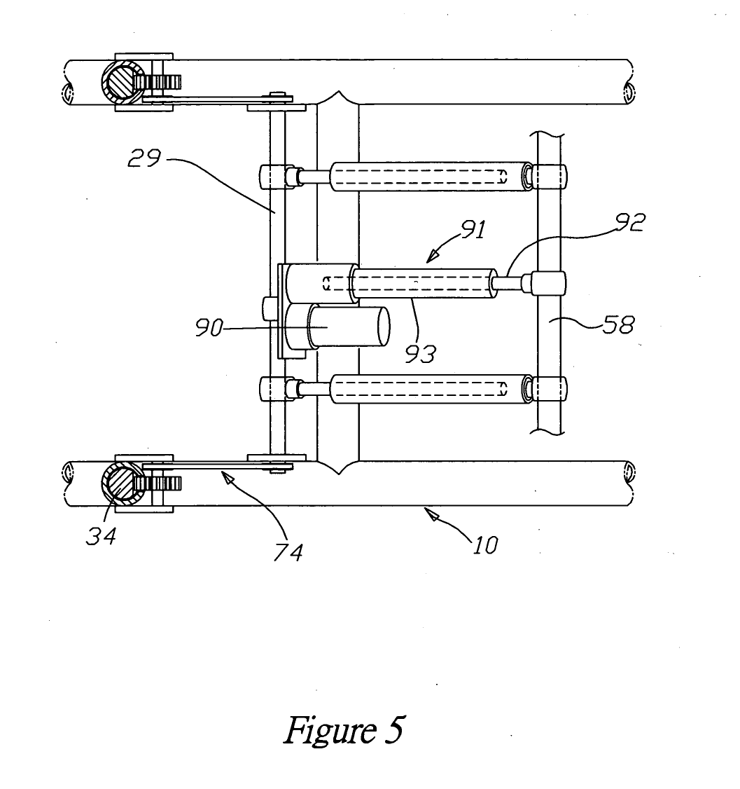

Refer to FIG. 5, which is another embodiment of the present invention. In this embodiment, a motor 90 is arranged between the rigid frames 10. The motor 90 provides a drive force to a gas spring 91. One endpoint of the gas spring 91 couples to the front cross frame 29, and the other endpoint of the gas spring 91 couples to the rear cross frame 58. The rear cross frame 58 comprises a longitudinal shaft 92 and a shaft cover 93 covering the outside of longitudinal shaft 92. The shaft of the longitudinal shaft 92 and shaft cover 93 are transformed by the motor's 90 drive extending the gas spring 91, causing the arm bar to rise. The front cross frame 29 is turned by extending of the gas spring 91 and the tooth frame 34 is turned downward to the ground, guided by the transformation combination 74.

Addition of the motor further increases the facility for changing the wheelchair's position easily, conveniently, and safely.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

1. A raising wheelchair comprising:
two rigid frames, each connected to a separate wheel, further comprising a front cross frame coupled between said rigid frames;
two fixing combinations, each fixing combination comprising a linking frame and a tooth frame on respective sides thereof, whereby the linking frame is coupled to said rigid frame and enfolds said tooth frame, the tooth frame comprising a tooth fitting;
two lever combinations, coupled and located at a top of said rigid frame, having a rear cross frame coupled between said lever combination;
a transformation combination coupled to said lever combination, gearing to said tooth frame, and
a motor, located between said rigid frame, for driving said transformation combination.

2. The wheelchair of claim 1, whereby the transformation combination further comprises a chain located between said front cross frame and said rear cross frame.

3. The wheelchair of claim 1, whereby the linking frame comprises a tooth grove appropriately located in relationship to said tooth fitting of said tooth frame.

4. The wheelchair of claim 1, further comprising a frame stop couples to said tooth frame for stopping.

5. The wheelchair of claim 1, whereby the lever combination further comprises an arm bar and a lever bar, said arm bar pivotally secured between said linking frame and said lever bar.

6. The wheelchair of claim 5, whereby the lever bar and arm bar pivot at an angle between a sitting and a raised position of the wheelchair.

7. The wheelchair of claim 5, said arm bar comprising a tab stop for stopping against said rigid frame.

8. The wheelchair of claim 1, whereby the transformation combination further comprises at least one gear for gearing to said tooth fitting of said tooth frame.

9. The wheelchair of claim 8, whereby the transformation combination further comprises at least one chain for receiving and guiding said gear.

10. The wheelchair of claim 1, further comprising a shaft support to couple between said front cross frame and said rear cross frame for increasing the stability when changing positions.

11. A raising wheelchair comprising:
two rigid frames, each connected to a separate wheel, with a front cross frame coupled between said rigid frames;
two fixing combinations, the fixing combinations comprising a linking frame and a tooth frame, whereby the linking frame is coupled to said rigid frame and encases said tooth frame, and whereby the tooth frame comprises a tooth fitting;
two lever combinations coupled and located at a top of said rigid frame, having at least one rear cross frame coupled between said lever combination; and
a transformation combination coupled to at least one gas spring of said lever combination for providing support to change wheelchair position, whereby the transformation combination gears to said tooth frame.

12. The wheelchair of claim 11, whereby the gas spring is locate between said front cross frame and said rear cross frame.

13. The wheelchair of claim 11, whereby the linking frame comprises a tooth grove located in relation to said tooth fitting of said tooth frame.

14. The wheelchair of claim 11, whereby the transformation combination further comprises at least one gear for gearing to said tooth fitting of said tooth frame.

15. The wheelchair of claim 14, whereby the transformation combination further comprises at least one chain for receiving said gear.

16. A raising wheelchair comprising:
a frame body, comprising two rigid frames and two linking frames, whereby the linking frames comprise a tooth frame;
two lever combinations located at a top of said rigid frames;
a transformation combination coupled to said frame body and guided by said lever combinations, whereby the transformation combination gears to said tooth frame;

17. The wheelchair of claim 16, whereby the frame body further comprises a gas spring, whereby one endpoint of the gas spring couples to said lever combination and another endpoint of the gas spring is coupled to the transformation combination.

18. The wheelchair of claim 16, whereby the frame body further comprises a shaft for extending, whereby one endpoint of said shaft couples to said lever combination and another end point of said shaft couples to said transformation combination.

19. A raising wheelchair comprising:
a wheeled-frame body, comprising two rigid frames and two linking frames, whereby the rigid frames further comprise a cross shaft coupled between said rigid frames,
two lever combinations located at tops of said rigid frames,
a motor coupled to said wheel-frame body, and
a gas spring for extending, guided by said motor, whereby the gas spring drives said lever combination, whereby one endpoint of said gas spring couples to said lever combination and another endpoint of said gas spring couples to said cross shaft.

20. The wheelchair of claim 19, whereby the gas spring further comprise a longitudinal shaft and a shaft cover, whereby the shaft cover encases at least a portion of an outside of said longitudinal shaft.
